(19) United States
(12) Patent Application Publication
(10) Pub. No.: US 2012/0138375 A1
(43) Pub. Date: Jun. 7, 2012

(54) REGENERATIVE BRAKING SYSTEM FOR AN ELECTRIC VEHICLE AND METHOD OF USE

(75) Inventor: Peter S. Hughes, South Harwich, MA (US)

(73) Assignee: VECTRIX INTERNATIONAL LIMITED, Kwai Chung (HK)

(21) Appl. No.: 12/959,780

(22) Filed: Dec. 3, 2010

(51) Int. Cl. B60L 11/18; B60T 13/74; B60L 7/24; B60T 1/10; B60K 1/00; B60L 7/10

(52) U.S. Cl. 180/65.1

(57) ABSTRACT

A regenerative braking system for a vehicle includes a combination regenerative braking and reverse switch operable between at least a regenerative braking mode and a reverse mode; a brake actuation device configured for movement by a user and disposed outside of a handlebar; a brake actuation device sensor assembly operatively coupled to the brake actuation device; and a regenerative device associated with a battery and at least one wheel for generating an electrical current by decelerating the wheel, and one or more controllers coupled to the brake actuation device sensor assembly, the battery, and the combination regenerative braking and reverse switch such that in the regenerative braking mode the one or more controllers cause the regenerative device to decelerate the vehicle and charge the battery and in the reverse mode the one or more controllers control the electric motor to drive the at least one wheel in reverse.

### FIELD OF THE INVENTION

The present invention generally relates to an electric vehicle having a regenerative braking system used to recover energy for an on-board rechargeable power supply. More particularly, the invention relates to rider controlled actuating devices for the regenerative braking system.

### BACKGROUND OF THE INVENTION

As exacerbation of air pollution by large numbers of internal combustion vehicles has become a significant concern in large cities, efforts are being made worldwide to provide efficient electric powered vehicles which do not discharge pollutant emissions. Large cities in developing countries which include high concentrations of scooters powered by two stroke engines are particularly affected by vehicle pollution. These two stroke scooters produce large quantities of pollutants and significant noise. Electric powered scooters, on the other hand, offer a means of transportation that emits substantially no pollutants and produces very little noise.

Electric scooters typically have a bank of batteries which provide power to a drive motor. These batteries must be recharged from time to time. This is typically done by plugging the batteries into an AC power outlet for a period of time to restore the depleted energy. However, to improve the autonomy of a vehicle, there is reason to place battery charging units and battery energy conserving units permanently onboard electric scooters. In particular, regenerative braking systems can be used to transform kinetic energy of the vehicle back into electrical energy to help recharge the vehicle batteries during the braking mode. This provides a braking system that is more energy efficient, and simpler, than that provided by friction brakes.

One system known for controlling regenerative braking in an electric vehicle is disclosed in U.S. Pat. No. 5,644,202 which teaches a regenerative braking control system that is capable of individually controlling braking force and recharging energy. The braking force and recharging energy are set based on the charge of the battery and motor speed to obtain an optimal braking force and an optimal recharging current. The system teaches establishing an optimal braking force and then providing a recharging current that is optimized so that the recharging current is increased when the battery voltage is low and is decreased when the battery voltage is high.

Another regenerative braking system for an electric vehicle is known from U.S. Pat. No. 5,615,933 which discloses a four wheeled vehicle having an electric propulsion motor, a regenerative brake control, and a friction anti-lock brake system (ABS) in which regenerative braking may be blended with friction braking when anti-lock braking is not activated. Regenerative braking, however, is ramped down or immediately removed when antilock braking is activated.

Similarly, U.S. Pat. No. 5,472,265 discloses an antilock braking apparatus having a regenerative braking part, a second braking part, an antilock brake system part, and a braking control part in which the antilock brake system part performs an ABS control process to control a braking force produced by either the regenerative braking part or the second braking part on the wheels. The braking control part changes the braking force produced by the other braking part on the wheels to equal zero when the antilock brake system part has started performing an ABS control process.

### SUMMARY OF THE INVENTION

An aspect of the present invention involves a vehicle including at least two wheels; an electric motor operatively coupled to at least one of the at least two wheels to drive the at least one wheel; a rechargeable battery; a handlebar for steering at least one wheel of the at least two wheels; and a regenerative braking system comprising: a combination regenerative braking and reverse switch operable between at least a regenerative braking mode and a reverse mode; a brake actuation device configured for movement by a user and disposed outside of the handlebar; a brake actuation device sensor assembly operatively coupled to the brake actuation device; a regenerative device associated with the batteries and at least one of the wheels for generating an electrical current by decelerating the wheel, and one or more controllers coupled to the brake actuation device sensor assembly, the battery, and the combination regenerative braking and reverse switch such that in the regenerative braking mode the one or more controllers cause the regenerative device to decelerate the vehicle and charge the battery and in the reverse mode the one or more controllers control the electric motor to drive the at least one wheel in reverse.

One or more implementations of the aspect of the invention described immediately above include(s) one or more of the following: the vehicle is a two wheeled vehicle; the brake actuation device is a hand brake lever; the brake actuation device is a foot brake pedal; the combination regenerative braking and reverse switch is operable between at least a regenerative braking mode, a reverse mode, and an off mode; the brake actuation device sensor assembly is a position sensor assembly; the position sensor assembly is a magnetic position sensor assembly; the brake actuation device sensor assembly is a pressure sensor assembly; the brake actuation device moves linearly and the brake actuation device sensor assembly is operatively coupled to the brake actuation device to translate the linear movement of the brake actuation device into rotational movement in the brake actuation device sensor assembly; the brake actuation device sensor assembly includes a magnet holder and a magnet carried by the magnet holder, the magnet operably coupled with the brake actuation device so that linear movement of the brake actuation device causes rotational movement in the magnet, the brake actuation device sensor assembly including a sensor configured to output a signal in response to rotational movement of the magnet, the signal reflective of either a position, or a change in position, of the brake actuation device; the vehicle includes a friction brake system, and the brake actuation device is operatively coupled to the friction brake system to decelerate the vehicle with the friction brake system independently of the regenerative braking force; and/or the vehicle includes a friction brake system, and the brake actuation device is operatively coupled to the friction brake system to decelerate the vehicle in cooperation with the regenerative braking system.

Other features and advantages of the present invention will become more readily apparent to those of ordinary skill in the art after reviewing the following detailed description and accompanying drawings.

### BRIEF DESCRIPTION OF THE DRAWINGS

The details of various embodiments present invention, both as to their structure and operation, may be gleaned in part by study of the accompanying drawings, in which like reference numerals refer to like parts, and in which:

FIG. 1A is a left side view of a scooter having a regenerative braking system of the present invention;

FIG. 1B is a top view of the scooter of FIG. 1;

FIG. 1C is a front elevational view of a handle bar assembly including the regenerative braking system of the present invention;

FIG. 2 is a top plan view of the handle bar assembly including the regenerative braking system of the present invention;

FIG. 3 is cross-sectional view of the handle bar assembly including the regenerative braking system of the present invention;

FIG. 4 is a schematic diagram of an embodiment of a regenerative braking system of the present invention;

FIG. 5A is a block diagram of an embodiment of an electric system for the scooter;

FIG. 5B is a flow chart of an exemplary regenerative and anti-lock braking method using the regenerative braking system of the present invention; and

FIG. 6 is a block diagram illustrating an example computer system that may be used in connection with various embodiments described herein.

### DETAILED DESCRIPTION OF PREFERRED EMBODIMENTS

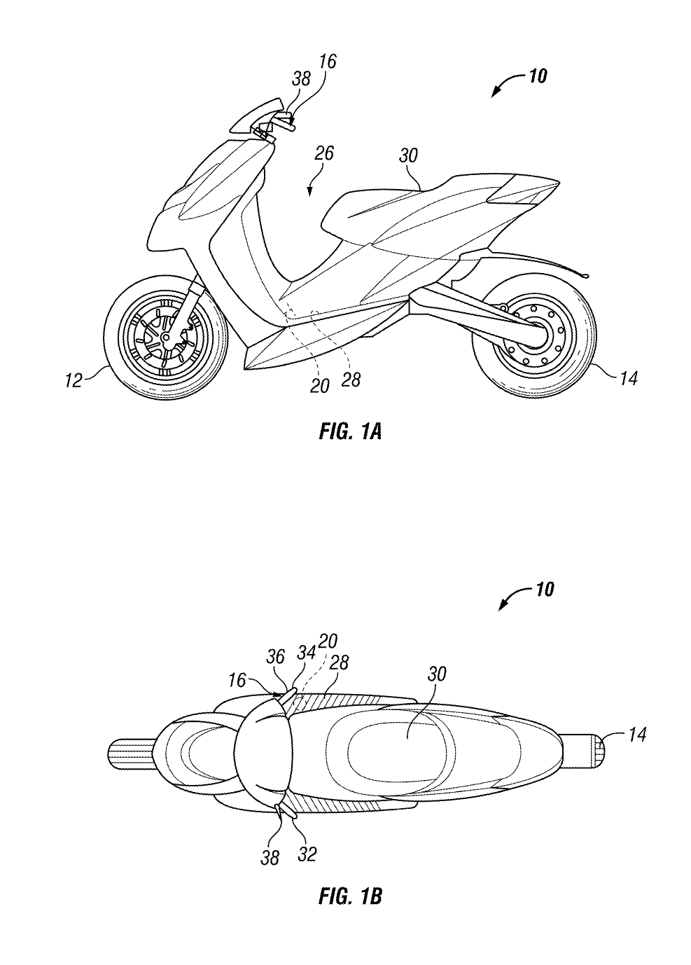

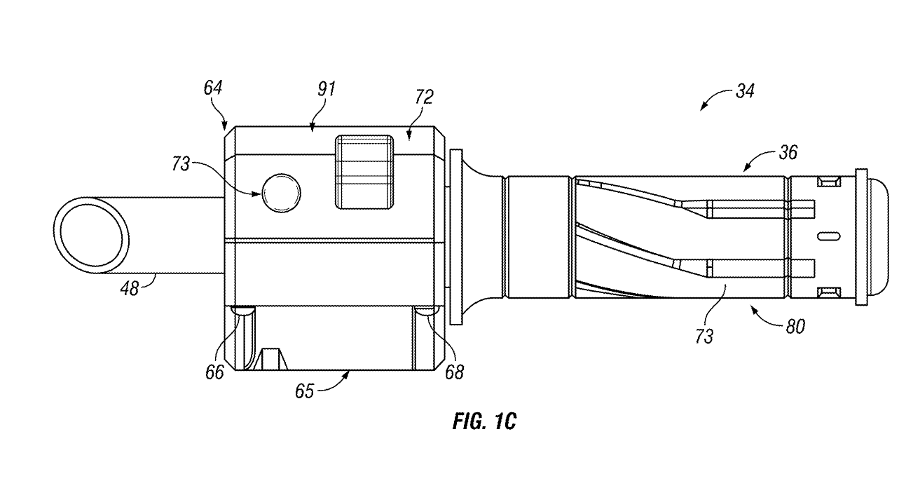

With reference to FIGS. 1A-6, a regenerative braking system 8 constructed in accordance with an embodiment of the present invention will be described. Before describing the regenerative braking system 8, a scooter 10, which the regenerative braking system 8 may be employed within, will first be described.

With reference to FIG. 1A, the scooter 10 includes two wheels, a front steerable wheel 12 and a rear drive wheel 14. The front wheel 12 is steerable by handlebar 16 and the scooter can be braked by means of a foot brake pedal 20, one or more hand brakes (e.g., left hand brake, right hand brake) 24, and/or an embodiment of a regenerative braking system 8, which will be described in more detail below. Preferably, the foot pedal 20 is located on one side of the vehicle 10 near the front of a rider's foot, so that a rider could readily press the pedal 20 with the bottom of the rider's foot. In the embodiment shown, the scooter has a pass-through 26 for facilitating mounting a rider so the rider's legs can be passed therethrough. The pass-through 26 preferably has a height of more than about half of the height between foot platform 28 and the portion 30 of the seat where the driver sits.

With reference to FIG. 1B, a handle bar 16 includes left and right handles 32, 34. In the embodiment shown, the handle bar 16 has a twist grip throttle 36 located on the right handle 34 and a hand brake lever 24 located on the left handle 32, in a configuration typical of European motor scooters, although this positioning is altered in other embodiments, and a hand brake lever 24 can be provided on both handles 32, 34, or on the right handle 34 as will be discussed/shown in more detail herein.

With reference to FIG. 1C, an embodiment of right handle 34 will be described. The right handle 34 includes a handle bar 48 on which a throttle housing 91 is mounted. Throttle housing 91 includes an upper housing 64 and a lower housing 65, which are preferably fastened together, such as by fastener 66 and 68. An emergency kill switch 72 and a combination regenerative braking and reverse switch 73 are disposed on the throttle housing 91, separately accessible for operation preferably with a rider's thumb. In alternative embodiments, the emergency kill switch 72 and/or the combination regenerative braking and reverse switch 73 are disposed in other locations on right handle 34 (and/or left handle 32). A grip 80 is mounted on the throttle 36 to allow for easy grasping and rotation of the throttle 36. Preferred grip 80 is made from an elastomer material, although other materials can be used as known in the art. In the embodiment shown, the combination regenerative braking and reverse switch 73 is push button thumb switch including a regenerative braking position/mode and a reverse position/mode. In alternative embodiments, the switch 73 may include one or more additional positions/modes (e.g., off position/mode).

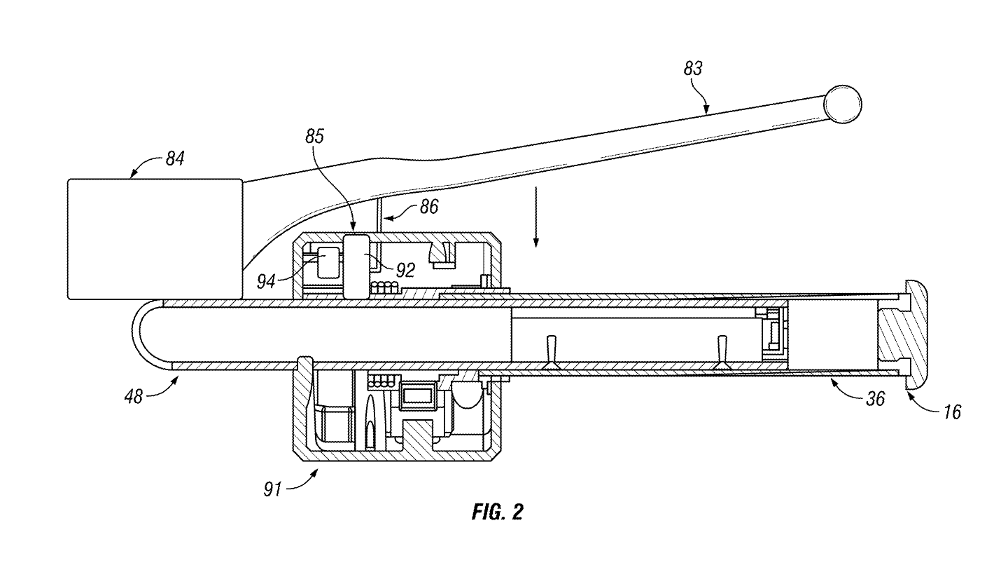

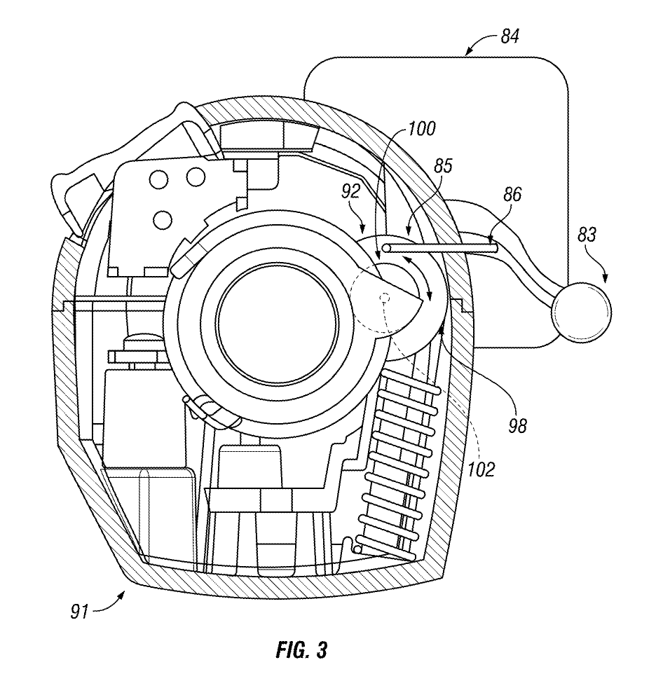

With reference to FIGS. 2 and 3, a brake actuation device 83 in the form of a right hand brake lever 38 is pivotally coupled via a master cylinder 84 to the right handle 34 and a brake lever position sensor assembly 85 is operably coupled to the hand brake lever 38 via a pivot arm 86. The brake lever position sensor assembly 85 is disposed within throttle housing 91. The brake lever position sensor assembly 85 is preferably configured for sensing a position of the brake lever 38 with respect to the handle 34, and generating a signal based on the sensed position for controlling braking regeneration of the vehicle and activating a reverse mode. The brake lever position sensor assembly 85 is preferably configured for sensing an absolute position of the throttle 30 without requiring relative movement of the brake lever 38, such as without requiring initial homing movement of the brake lever 38. A sensed member, which is preferably a magnetic member 28, has a magnetic field and is coupled to the pivot arm 86, which imparts rotational movement thereto. Preferably, brake lever position sensor 94 is configured to sense the magnetic field, across a contactless gap, to sense the position of the brake lever 38. The brake lever position sensor 94 is preferably configured for sensing the orientation of the magnetic field to sense the position of the throttle 30. In the preferred embodiment, the sensor 94 is fixed within/relative to the throttle housing 91. The signal from the brake lever position sensor 37 may be transmitted by wired or wireless means to a supervisory controller 96.

The magnetic member 92 is cylindrical disk-shaped magnet holder 98 with a disk-shaped cylindrical magnet 100 that includes a cylindrical axis 102. In alternative embodiments, other shapes of magnets are used. The magnet 100 is preferably a permanent magnet of a magnetic material, such as AINiCo, SmCo5, or NdFeB. Typically, the magnet 100 is about 5-7 mm in diameter and about 2-4 mm in height, while the dimensions can be varied. The magnetic poles can be disposed at different locations with respect to the axis of rotation. The magnetic poles can also be disposed at different eccentric locations with respect to the axis 102. In the preferred embodiment, the magnetic poles are disposed radially symmetrically with respect to axis 102. Most preferably, the axis of rotation is coaxial with the cylindrical axis 102. Other embodiments include configurations with various different spatial relationship between the magnetic member 92 and the sensor 37. For example, in one embodiment the relationship between the magnetic field at the sensor 37 and the change in position of the brake lever 38 is sufficiently nonlinear such that electronics or other means of compensation may be required to determine the position of the brake lever.

The brake lever position sensor 37 may be mounted generally centrally on a sensor printed circuit board, with the magnetic member 92 disposed adjacent thereto, but without contacting the throttle positioning sensor 37. Preferably, the brake lever position sensor 37 comprises one or more Hall effect sensors, which can be provided as a differential hall effect sensor. The differential hall effect brake lever position sensor 37 may be configured for sensing an absolute orientation without requiring movement of the brake lever 38. Preferably, the distance between the magnetic member 92 and the brake lever position sensor 37 should be about 0.5 mm to 2.5 mm, and more preferably about 1.8 mm. The magnetic member axis 102 is preferably aligned within about 0.10 mm and 0.50 mm, and more preferably within about 0.25 mm, of the center of the brake lever position sensor 37. In alternative embodiments, dimensions of the magnetic member 92 and the brake lever position sensor 37 are varied. In a preferred embodiment, the signal from the brake lever position sensor 37 is a pulse-width modulated signal in which the pulse-width modulated signal is related to the sensed position. Alternative output signal from the brake lever position sensor 37 can be, for example, a serial bit stream.

Although the brake lever position sensor assembly 85 is shown and described herein as a magnetic position sensor that implements regenerative braking in proportion to sensed position, in alternative embodiments, the sensor assembly 85 is a pressure sensor assembly with one or more pressure sensors that implement regenerative braking in proportion to sensed pressure, the sensor assembly 85 includes both a position sensor assembly 85 and a pressure sensor assembly, or the sensor assembly 85 includes other type(s) of sensor assembly/assemblies.

Although the regenerative braking system 8 is shown and described as including a braking actuation device 83 in the form of a right hand brake lever 38, in alternative embodiments, the braking actuation device 83 is a left hand brake lever 38, a right hand brake lever 38, a foot brake pedal 20, a thumb switch, a thumb lever, and/or a twist grip throttle.

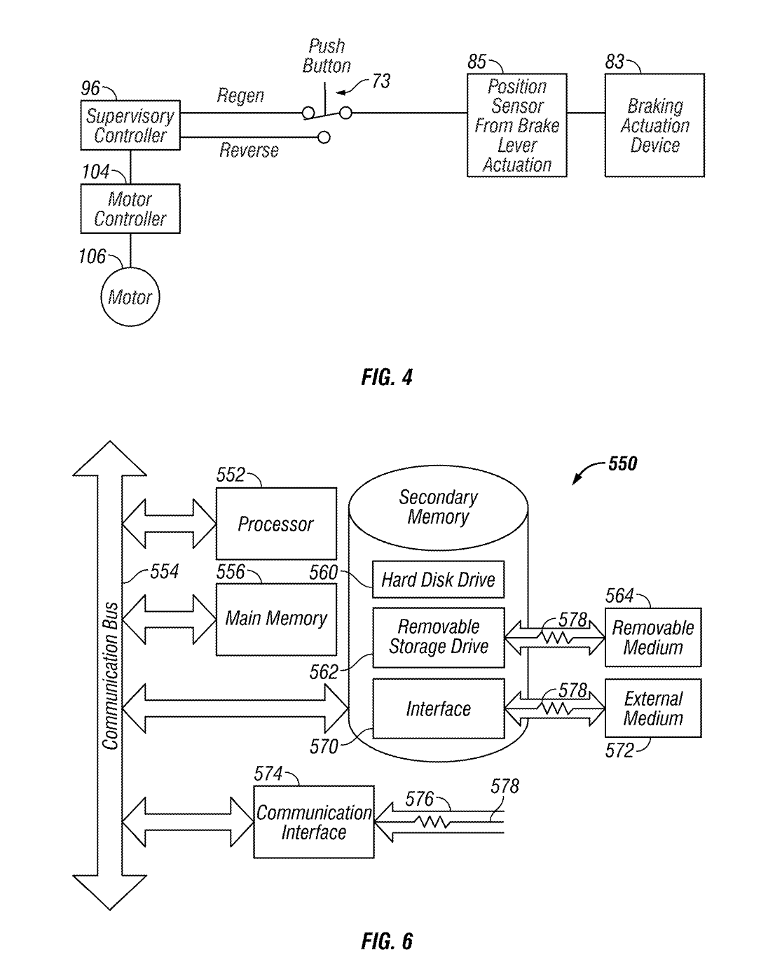

With reference to FIG. 4, the regenerative braking system 8 includes the brake actuation device (e.g., brake lever, brake pedal) 83, the sensor assembly (e.g., magnetic position sensor assembly, pressure sensor) 85, the combination regenerative braking and reverse switch 73, a supervisory controller 96, a motor controller 104, and an electric motor 106.

As shown in FIG. 2, the brake actuation device 83 is disposed outside of the handlebar 16. This eliminates the need for a tightly toleranced handlebar/bore (which adds to cost) to accommodate a regen throttle assembly.

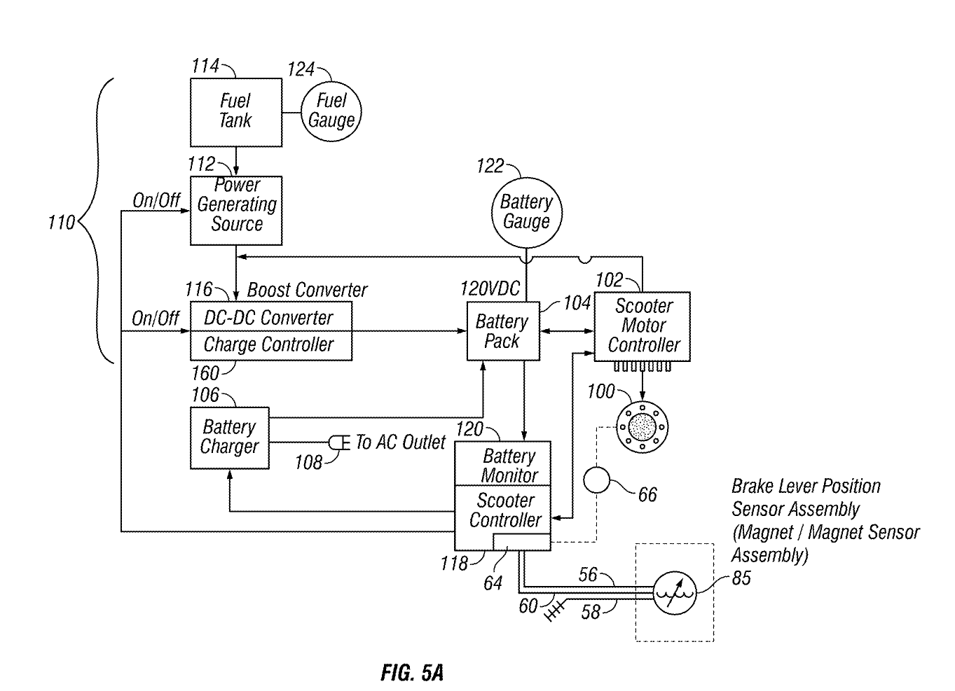

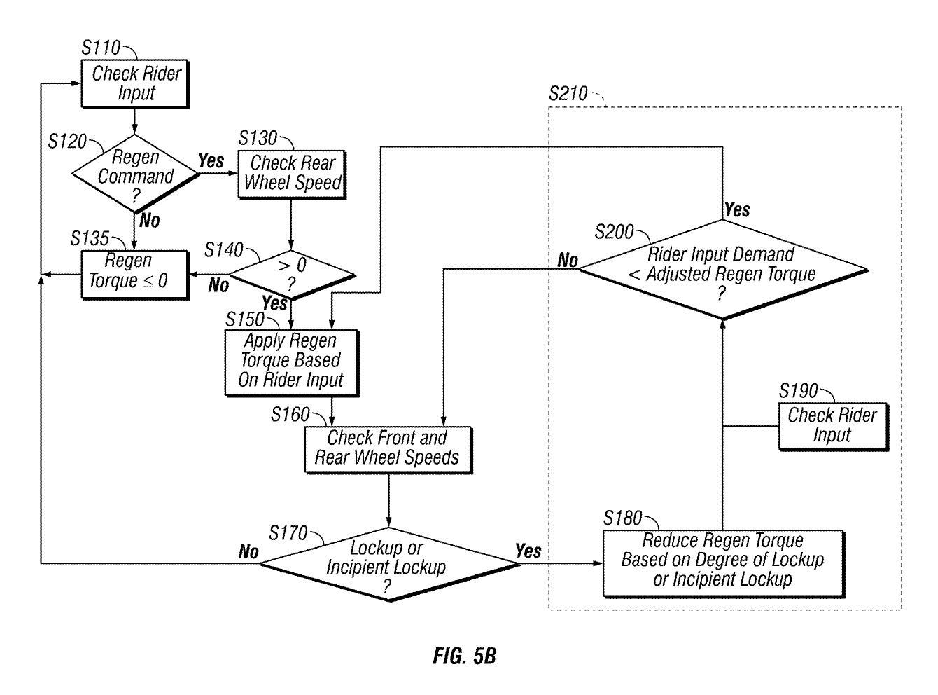

In use, the combination regenerative braking and reverse switch 73 is put (e.g. pressed with one's thumb) in a regenerative braking position/mode. In the regenerative braking position/mode, as the user progressively engages the brake actuation device 83 (e.g., squeezes the right hand brake lever 38 towards the throttle 30 in the brake lever travel direction/arrow shown in FIGS. 2, 3, presses on foot brake pedal 20), linear movement of the brake actuation device 83 imparts corresponding rotational movement (in the rotational direction shown by the arrow in FIG. 3) to the magnetic member 92 via the pivot arm 86. The brake lever position sensor 37 senses the magnetic field of the magnetic member for sensing the position of the brake lever 38. The signal from the brake lever position sensor 37 is transmitted to the supervisory controller 96. The supervisory controller 96 communicates with the motor controller 104 for controlling braking regeneration. One or both of the supervisory controller 96 and the motor controller 104 include one or more regenerative braking algorithms/methods. An exemplary regenerative braking algorithm will be described below with respect to FIG. 5. In alternative embodiments, other regenerative braking algorithms are used.

In another embodiment, a first portion of brake control travel of the brake actuation device 83 (e.g., right hand brake lever 38, foot brake pedal 20), such as about 10 percent, activates regenerative braking, and further actuation activates one or more different types of braking, such as friction braking, in addition to or instead of the regenerative braking.

To put the vehicle 10 in reverse, the combination regenerative braking and reverse switch 73 is put (e.g. pressed with one's thumb) in a reverse position/mode. The braking actuation device 83 (e.g., brake lever, brake pedal) 83 must be engaged (e.g., brake lever squeezed) to enable reverse mode. In the reverse mode, the vehicle 10 has reverse capability for very low-speed maneuvering (with feet on the ground and brake actuation device 83 engaged). Maximum driving torque in reverse is greatly reduced compared to forward speeds and the vehicle speed would be limited to a walking pace.

As indicated above, in a further embodiment of the combination regenerative braking and reverse switch 73, the switch 73 is put (e.g. pressed with one's thumb) in an “off/disabled/disengaged” position/mode, where both regenerative braking mode and reverse mode are off/disabled/disengaged.

With reference to FIG. 5A another embodiment of a regenerative braking system will be described. In one or more embodiments, one or more of the features of the regenerative braking system shown and described with respect to FIG. 5A may be incorporated into the regenerative braking system 8 of the present invention.

The rider input device (e.g., potentiometer 40, brake lever position sensor assembly 85) is operably configured to translate a mechanical rider input from an actuating device into an electrical signal which is transmitted to a regenerative braking control module 64 comprising a microprocessor on the scooter controller 118. The control module 64 further receives input signals from at least one process monitoring sensor 66. The process monitoring sensor 66 may provide instrumentation data such as drive wheel speed, front wheel speed, and vehicle accelerometer measurements.

In use, the regenerative braking control module 64 receives the regenerative braking system input signals, applies an algorithm to the signals, and produces an output signal to the motor controller 102 for regulating regenerative braking torque to the drive wheel. Charging of the battery pack 104 during regenerative braking is regulated by the scooter controller 118 and charging controller 160.

An electric scooter motor 100 (e.g., three-phase slotted brushless permanent magnet motor) provides the driving power to drive the scooter. Scooter motor 100 receives a three-phase voltage from scooter motor controller 102. The motor controller has the battery DC voltage as its input and converts the battery voltage to a three-phase output to the motor. Preferably, scooter motor controller 102 outputs a modulated signal, such as pulse width modulation, to drive the scooter motor 100. The scooter motor controller 102 includes high power semiconductor switches which are gated (controlled) to selectively produce the waveform necessary to connect the battery pack 104 to the scooter motor.

Battery pack 104 preferably includes sufficient batteries connected in series to provide at least 100 VDC. The battery pack 104 preferably comprises either lead-acid batteries or Ni—Zn batteries, although other battery types such as nickel metal hydride and lithium ion can be used. Regardless of which types of batteries are used, it is crucial for the purposes of the present invention that the batteries be rechargeable. A conventional battery charger 106 is one way in which the battery pack 104 is recharged. Battery charger 106 may reside onboard the scooter and is connectable to an AC outlet via a plug 108 or the like. Alternatively, the battery charger 106 may remain off of the vehicle and be connected to the scooter only during high current charging sessions. As used herein, “rechargeable battery” includes one or more rechargeable batteries.

In addition to the battery charger 106, which connects to an AC outlet to recharge the battery pack 104, an onboard charging system 110 can also be incorporated on the scooter. The embodiment of FIG. 4 is a hybrid vehicle, which also includes onboard charging system that comprises an onboard power generating source 112, a fuel supply 114 which feeds the onboard power generating source 112, and a converter/charge controller 116 which transforms the output of the onboard power generating source 112 into a form suitable for charging the battery pack 104. The onboard power generating source may include a fuel cell, an internal combustion engine, or both. Other embodiments are not hybrids, and do not include an onboard power generating source.

A scooter controller 118 sends signals to the motor controller 102, the battery charger 106 (when provided onboard the scooter), the onboard power generating source 112, and the converter/charge controller 116. The charge of the battery pack is monitored via a battery monitor 120 which, in turn, is connected to the scooter controller 118 to provide information which may affect the operation of the scooter controller. The energy state of the battery pack is displayed on a battery gauge 122 so that the user can monitor the condition of the battery pack 104, much like a fuel gauge is used to monitor a gasoline powered scooter. The status of the fuel supply 114 is similarly displayed on a fuel gauge 124 for the user's convenience.

With reference to FIG. 5B an exemplary regenerative and anti-lock braking method/algorithm for the regenerative braking system shown and described with respect to FIG. 5A will be described. In one or more embodiments, one or more of the steps of the method/algorithm may be performed with the regenerative braking system 8 of the present invention. For the purpose of this discussion, a velocity greater than zero indicates a wheel speed corresponding to forward movement of the vehicle. Conversely, a velocity less than zero indicates a wheel speed corresponding to backward movement of the vehicle. A control module monitors a potentiometer signal S110 and determines whether the rider has demanded regenerative braking S120 (e.g., via actuation of combination regenerative braking and reverse switch 73 and engaging brake lever 38), If regenerative braking is demanded by the rider, the scooter controller evaluates data from the drive wheel speed sensors and determines whether the drive wheel has a velocity greater than zero S130. If the rider has demanded regenerative braking and the drive wheel velocity is not greater than zero S135, no regenerative braking torque is applied and the controller returns to step S110.

If, however, the rider has demanded regenerative braking and the drive wheel velocity is greater than zero S140, the control module commands the motor controller to apply a regenerative braking torque to the drive motor S150. The magnitude of the regenerative braking torque is determined by the control module based on the rider demand (i.e., potentiometer signal) and other operational parameters, as described in more detail below. In one embodiment, the regenerative braking torque increases with an increase in the signal from the sensor assembly 85.

When regenerative braking torque is applied S150, the control module evaluates signals from front and rear wheel sensors to determine the velocity of each wheel S160. The front and rear wheel speeds are evaluated by the control module to determine whether to commence anti-lock regenerative braking S170 and anti-lock regenerative braking is started when a trigger is activated. In one embodiment, the trigger is activated when the front and rear wheel speeds differ by a set value. For example, the trigger may be programmed to activate anti-lock regenerative braking when the control module determines that the front and rear wheel speeds differ by more than 5 percent.

If lock-up conditions have not occurred or are not about to occur (i.e., the anti-lock regenerative braking trigger is not activated) the demanded regenerative braking torque remains applied to the drive wheel and an updated regenerative braking demand signal is polled S110. Alternatively, if lock-up conditions are determined by the control module (i.e., the anti-lock regenerative braking trigger is activated) the control module signals the motor controller to reduce the demanded regenerative braking torque S180.

An adjusted regenerative braking torque is determined by the control module based on a predetermined relationship between the applied regenerative braking torque and the lock-up conditions which activated the trigger. For example, a memory associated with the control module may store data D(x1, x2, . . . , xN) as a map, or look-up table, which represents the duty factors for regenerative braking torque as a function of operational data from N parameters such as detected motor speed, regenerative braking potentiometer signal, front and rear wheel velocity data, and the like. As an example, in the case where N=2, the data D(x1, x2) may store information for x1=regenerative braking potentiometer signal, x2=motor speed. The control module would choose duty factor data D(x1, x2) representing the adjusted regenerative braking torque that corresponds to operational data from the duty factor storage device. If any duty factor data D(x1, x2) were not found in the duty factor map storage device for the given operational data, duty factor data would be calculated by interpolation to generate an adjusted regenerative braking torque, or the operational data itself may be truncated or rounded off so that it corresponds to indices in the data table D(x1, x2).

After adjusting the regenerative braking torque, the control module polls the potentiometer signal S190 to determine an updated demand for regenerative braking torque. The updated demand is compared to the adjusted torque S200. In the event the updated demand is less than the adjusted torque the control module signals the motor controller to apply the updated demanded regenerative braking torque S150. Alternatively, if the updated regenerative braking torque demanded by the rider is not less than the adjusted regenerative braking torque, the control module continues to signal the motor controller to apply the adjusted regenerative braking torque.

After completing the anti-lock subroutine S210, the control module re-polls the process sensors S160 and tests the signals for the lock-up trigger condition S170. If the trigger condition is satisfied, then the applied regenerative braking torque is adjusted S180 and evaluated as described above S190, S200. If the trigger condition is not satisfied (i.e., lock up has not occurred and is not about to occur) the control module continues to signal the motor controller to apply the applied regenerative braking torque to the drive motor and returns to the start of the logic sequence S110.

FIG. 6 is a block diagram illustrating an example computer system 550 that may be used in connection with various embodiments described herein. For example, but not by way of limitation, the computer system 550 may be used in conjunction with the supervisory controller 96, the motor controller 104, or other computers/controllers shown and/or discussed herein. However, other computer systems and/or architectures may be used, as will be clear to those skilled in the art.

The computer system 550 preferably includes one or more processors, such as processor 552. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 552.

The processor 552 is preferably connected to a communication bus 554. The communication bus 554 may include a data channel for facilitating information transfer between storage and other peripheral components of the computer system 550. The communication bus 554 further may provide a set of signals used for communication with the processor 552, including a data bus, address bus, and control bus (not shown). The communication bus 554 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPIB”), IEEE 696/S-100, and the like.

Computer system 550 preferably includes a main memory 556 and may also include a secondary memory 558. The main memory 556 provides storage of instructions and data for programs executing on the processor 552. The main memory 556 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 558 may optionally include a hard disk drive 560 and/or a removable storage drive 562, for example a floppy disk drive, a magnetic tape drive, a compact disc (“CD”) drive, a digital versatile disc (“DVD”) drive, etc. The removable storage drive 562 reads from and/or writes to a removable storage medium 564 in a well-known manner. Removable storage medium 564 may be, for example, a floppy disk, magnetic tape, CD, DVD, etc.

The removable storage medium 564 is preferably a computer readable medium having stored thereon computer executable code (i.e., software) and/or data. The computer software or data stored on the removable storage medium 564 is read into the computer system 550 as electrical communication signals 578.

In alternative embodiments, secondary memory 558 may include other similar means for allowing computer programs or other data or instructions to be loaded into the computer system 550. Such means may include, for example, an external storage medium 572 and an interface 570. Examples of external storage medium 572 may include an external hard disk drive or an external optical drive, or and external magneto-optical drive.

Other examples of secondary memory 558 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are any other removable storage units 572 and interfaces 570, which allow software and data to be transferred from the removable storage unit 572 to the computer system 550.

Computer system 550 may also include a communication interface 574. The communication interface 574 allows software and data to be transferred between computer system 550 and external devices (e.g. printers), networks, or information sources. For example, computer software or executable code may be transferred to computer system 550 from a network server via communication interface 574. Examples of communication interface 574 include a modem, a network interface card (“NIC”), a communications port, a PCMCIA slot and card, an infrared interface, and an IEEE 1394 fire-wire, just to name a few.

Communication interface 574 preferably implements industry promulgated protocol standards, such as CANbus (controller area network), Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 574 are generally in the form of electrical communication signals 578. These signals 578 are preferably provided to communication interface 574 via a communication channel 576. Communication channel 576 carries signals 578 and can be implemented using a variety of wired or wireless communication means including wire or cable, fiber optics, conventional phone line, cellular phone link, wireless data communication link, radio frequency (RF) link, or infrared link, just to name a few.

Computer executable code (i.e., computer programs or software) is stored in the main memory 556 and/or the secondary memory 558. Computer programs can also be received via communication interface 574 and stored in the main memory 556 and/or the secondary memory 558. Such computer programs, when executed, enable the computer system 550 to perform the various functions of the present invention as previously described.

In this description, the term “computer readable medium” is used to refer to any media used to provide computer executable code (e.g., software and computer programs) to the computer system 550. Examples of these media include main memory 556, secondary memory 558 (including hard disk drive 560, removable storage medium 564, and external storage medium 572), and any peripheral device communicatively coupled with communication interface 574 (including a network information server or other network device). These computer readable mediums are means for providing executable code, programming instructions, and software to the computer system 550.

In an embodiment that is implemented using software, the software may be stored on a computer readable medium and loaded into computer system 550 by way of removable storage drive 562, interface 570, or communication interface 574. In such an embodiment, the software is loaded into the computer system 550 in the form of electrical communication signals 578. The software, when executed by the processor 552, preferably causes the processor 552 to perform the inventive features and functions previously described herein.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, and methods described in connection with the embodiments disclosed herein can be implemented or performed with a general purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The above figures may depict exemplary configurations for the invention, which is done to aid in understanding the features and functionality that can be included in the invention. The invention is not restricted to the illustrated architectures or configurations, but can be implemented using a variety of alternative architectures and configurations. Additionally, although the invention is described above in terms of various exemplary embodiments and implementations, it should be understood that the various features and functionality described in one or more of the individual embodiments with which they are described, but instead can be applied, alone or in some combination, to one or more of the other embodiments of the invention, whether or not such embodiments are described and whether or not such features are presented as being a part of a described embodiment. Thus the breadth and scope of the present invention, especially in any following claims, should not be limited by any of the above-described exemplary embodiments.

Terms and phrases used in this document, and variations thereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although item, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

I claim:

1. A vehicle, comprising:
at least two wheels;
an electric motor operatively coupled to at least one of the at least two wheels to drive the at least one wheel;
a rechargeable battery;
a handlebar for steering at least one wheel of the at least two wheels; and
a regenerative braking system comprising:
a combination regenerative braking and reverse switch operable between at least a regenerative braking mode and a reverse mode;
a brake actuation device configured for movement by a user and disposed outside of the handlebar;
a brake actuation device sensor assembly operatively coupled to the brake actuation device;
a regenerative device associated with the batteries and at least one of the wheels for generating an electrical current by decelerating the wheel, and
one or more controllers coupled to the brake actuation device sensor assembly, the battery, and the combination regenerative braking and reverse switch such that in the regenerative braking mode the one or more controllers cause the regenerative device to decelerate the vehicle and charge the battery and in the reverse mode the one or more controllers control the electric motor to drive the at least one wheel in reverse.

2. The vehicle of claim 1, wherein the vehicle is a two wheeled vehicle.

3. The vehicle of claim 1, wherein the brake actuation device is a hand brake lever.

4. The vehicle of claim 1, wherein the brake actuation device is a foot brake pedal.

5. The vehicle of claim 1, wherein the combination regenerative braking and reverse switch is operable between at least a regenerative braking mode, a reverse mode, and an off mode.

6. The vehicle of claim 1, wherein the brake actuation device sensor assembly is a position sensor assembly.

7. The vehicle of claim 6, wherein the position sensor assembly is a magnetic position sensor assembly.

8. The vehicle of claim 1, wherein the brake actuation device sensor assembly is a pressure sensor assembly.

9. The vehicle of claim 1, wherein the brake actuation device moves linearly and the brake actuation device sensor assembly is operatively coupled to the brake actuation device to translate the linear movement of the brake actuation device into rotational movement in the brake actuation device sensor assembly.

10. The vehicle of claim 9, wherein the brake actuation device sensor assembly includes a magnet holder and a magnet carried by the magnet holder, the magnet operably coupled with the brake actuation device so that linear movement of the brake actuation device causes rotational movement in the magnet, the brake actuation device sensor assembly including a sensor configured to output a signal in response to rotational movement of the magnet, the signal reflective of either a position, or a change in position, of the brake actuation device.

11. The electric vehicle of claim 1, wherein the vehicle includes a friction brake system, and the brake actuation device is operatively coupled to the friction brake system to decelerate the vehicle with the friction brake system independently of the regenerative braking force.

12. The electric vehicle of claim 1, wherein the vehicle includes a friction brake system, and the brake actuation device is operatively coupled to the friction brake system to decelerate the vehicle in cooperation with the regenerative braking system.
